(19) United States
(12) Patent Application Publication
(10) Pub. No.: US 2015/0365785 A1
(43) Pub. Date: Dec. 17, 2015

(54) SYSTEM AND METHOD FOR DETECTING A HANDSHAKE SIGNAL

(71) Applicants: Sascha Simon, Warwick, NY (US); Zvi Huber, Great Falls, VA (US)

(72) Inventors: Sascha Simon, Warwick, NY (US); Zvi Huber, Great Falls, VA (US)

(21) Appl. No.: 14/818,802

(22) Filed: Aug. 5, 2015

Related U.S. Application Data
(63) Continuation-in-part of application No. 14/072,231, filed on Nov. 5, 2013.
Application No. 14/072,231 is a continuation-in-part of application No. 14/095,156, filed on Dec. 3, 2013.
Application No. 14/095,156 is a continuation-in-part of application No. 14/105,744, filed on Dec. 13, 2013, now Pat. No. 8,989,952.
Application No. 14/105,744 is a continuation-in-part of application No. 14/105,934, filed on Dec. 13, 2013.
Application No. 14/105,934 is a continuation-in-part of application No. 14/136,467, filed on Dec. 20, 2013.
Application No. 14/136,467 is a continuation-in-part of application No. 14/664,409, filed on Mar. 20, 2015.
Application No. 14/664,409 is a continuation-in-part of application No. 14/664,424, filed on Mar. 20, 2015.
(60) Provisional application No. 62/033,278, filed on Aug. 5, 2014.
(60) Provisional application No. 62/033,284, filed on Aug. 5, 2014.
(60) Provisional application No. 62/033,290, filed on Aug. 5, 2014.

(51) Int. Cl. H04W 4/00; H04W 76/02; H04W 4/02; H04W 8/00

(52) U.S. Cl. CPC H04W 4/008; H04W 8/005; H04W 76/02; H04W 4/02

(57) ABSTRACT

A device is provided for use with a wireless transceiver operable to transmit a handshake signal within a short wavelength frequency band. The device includes a processing component, a location determining component, a mode determining component, a detecting component and a transmitting component. The processing component is operable to operate in a first mode and a second mode. The location determining component determines when the processing component is in a predetermined location and generates a location signal when the processing component is in the predetermined location. The mode determining component generates a location mode signal based on the location signal. The detecting component detects, based on the location signal, the handshake signal and generates a wake-up signal based on the handshake signal. The transmitting component transmits, based on the wake-up signal, a transmission signal to the wireless transceiver within the short wavelength frequency band.

The present application claims priority from: U.S. Provisional Application No. 61/740,814 filed Dec. 21, 2012; U.S. Provisional Application No. 61/740,831 filed Dec. 21, 2012; U.S. Provisional Application No. 61/740,851 filed Dec. 21, 2012; and U.S. Provisional Application No. 61/745,677 filed Dec. 24, 2012, U.S. Provisional Application No. 61/955,995 filed Mar. 20, 2014, U.S. Provisional Application No. 62/033,278 filed Aug. 5, 2014, U.S. Provisional Application No. 62/033,284 filed Aug. 5, 2014 and U.S. Provisional Application No. 62/033,290 filed Aug. 5, 2014, the entire disclosures of which are incorporated herein by reference. The present application is a continuation-in-part of U.S. application Ser. No. 14/072,231 filed Nov. 5, 2013, is a continuation-in-part of U.S. application Ser. No. 14/095,156 filed Dec. 3, 2013, is a continuation-in-part of U.S. application Ser. No. 14/105,744 filed Dec. 13, 2013, is a continuation-in-part of U.S. application Ser. No. 14/105,934 filed Dec. 13, 2013, is a continuation-in-part of U.S. application Ser. No. 14/136,467 filed Dec. 20, 2013, is a continuation-in-part of U.S. application Ser. No. 14/664,409 filed Mar. 20, 2015 and is a continuation-in-part of U.S. application Ser. No. 14/664,424 filed Mar. 20, 2015, the entire disclosures of which are incorporated herein by reference.

### BACKGROUND

Many smartphones and other wireless communication devices are able to wirelessly connect to a network via a short wavelength frequency band such as that used in the Bluetooth™ standard.

In order to connect to the network, a transmitter within the network may broadcast a handshake signal, searching for a receiver to connect. A wireless communication device, such as a smartphone, may receive the broadcast when the wireless communication device is within the transmitter's broadcast range. Once the handshake signal is received, the wireless communication device may complete a handshake procedure by transmitting a responding handshake signal to the broadcasting transmitter. Once a handshake process is completed between the wireless communication device and the transmitter, the wireless communication device will be wirelessly connected to the network via the short wavelength frequency band.

Transmitting data via the short wavelength frequency band through the connected network is sometimes more cost effective and faster than transmitting data over a cellphone network. For this reason, it is beneficial for wireless communication deices to search for and connect to such short wavelength frequency band enabled wireless networks that are additionally connected to a cellular phone network. Accordingly, many wireless communication devices automatically and constantly search for such networks by searching for such handshake broadcasts.

However, such short wavelength frequency enable wireless networks that are additionally connected to a cellular phone network are not yet very prevalent. As such, in many cases, the wireless communication device wastes power searching for a handshake signal. This waste of power may be substantial, draining the battery of the wireless communication device.

What is needed is a system and method to reduce the likelihood of a wireless communication system of fruitlessly searching for a short wavelength frequency band handshake to connect to a wireless network.

### SUMMARY

The present invention provides a system and method to detect a handshake signal of a vehicle when the device is in a location mode.

Various embodiments described herein are drawn to a device for use with a wireless transceiver operable to transmit a handshake signal within a short wavelength frequency band. The device includes a processing component, a location determining component, a mode determining component, a detecting component and a transmitting component. The processing component is operable to operate in a first mode and a second mode. The location determining component determines when the processing component is in a predetermined location and generates a location signal when the processing component is in the predetermined location. The mode determining component generates a location mode signal based on the location signal. The detecting component detects, based on the location signal, the handshake signal and generates a wake-up signal based on the handshake signal. The transmitting component transmits, based on the wake-up signal, a transmission signal to the wireless transceiver within the short wavelength frequency band.

### BRIEF SUMMARY OF THE DRAWINGS

The accompanying drawings, which are incorporated in and form a part of the specification, illustrate an exemplary embodiment of the present invention and, together with the description, serve to explain the principles of the invention. In the drawings:

FIG. 1 illustrates a person walking with a communication device in accordance with aspects of the present invention;

FIG. 2 illustrates a person with a communication device, in an office, in accordance with aspects of the present invention;

FIG. 3 illustrates a person with a communication device walking toward to vehicle;

FIG. 4 illustrates when a person (not shown) is sitting in a vehicle and is using a device in accordance with aspects of the preset invention;

FIG. 5 illustrates an example method of detecting and connecting to a short wavelength frequency band wireless network in accordance with aspects of the present invention;

FIG. 6 illustrates an example device in accordance with aspects of the present invention;

FIG. 7 illustrates an example method of registering a handshake signal in accordance with aspects of the present invention;

FIG. 8 illustrates an example controlling component of the device of FIG. 6;

FIG. 9 illustrates an example parameter-detecting component of the device of FIG. 6;

FIG. 10 illustrates a method for detecting a handshake signal when in a registered vehicle while operating in a registered mode in accordance with aspects of the present invention;

FIG. 11 illustrates an example method of generating a signature associated with a handshake signal in accordance with aspects of the present invention; and

FIG. 12 illustrates an example method of verifying a handshake signal in accordance with aspects of the present invention.

### DETAILED DESCRIPTION

Aspects of the present invention are drawn to a system and method for determining whether a device is in a location by utilizing field properties within and/or near the specific location.

Aspects of the present invention are drawn to detecting a handshake signal of a short wavelength frequency band transmitter using a smartphone.

Aspects of the present invention are drawn to a smartphone automatically connecting to a short wavelength frequency band network if short wavelength frequency band handshake is detected.

As used herein, the term “smartphone” includes cellular and/or satellite radiotelephone(s) with or without a display (text/graphical); Personal Communications System (PCS) terminal(s) that may combine a radiotelephone with data processing, facsimile and/or data communications capabilities; Personal Digital Assistant(s) (PDA) or other devices that can include a radio frequency transceiver and a pager, Internet/Intranet access, Web browser, organizer, calendar and/or a global positioning system (GPS) receiver; and/or conventional laptop (notebook) and/or palmtop (netbook) computer(s), tablet(s), or other appliance(s), which include a radio frequency transceiver. As used herein, the term “smartphone ” also includes any other radiating user device that may have time-varying or fixed geographic coordinates and/or may be portable, transportable, wearable, installed in a vehicle (aeronautical, maritime, or land-based) and/or situated and/or configured to operate locally and/or in a distributed fashion over one or more location(s).

As used herein, the phrase “short wavelength frequency band,” includes a frequency band selected from a group consisting of a 2.4 GHz to 2.5 GHz frequency band, a 3.64 GHz to 3.9 GHz frequency band, a 5.18 GHz to 5.83 GHz frequency band, a 490 MHz to 910 MHz frequency band and a 59.0-64.0 GHz frequency band. In non-limiting example embodiments discussed herein, the 2.4 GHz to 2.5 GHz frequency band is used.

Handshaking is an automated process of negotiation that dynamically sets parameters of a communications channel established between two entities before normal communication over the channel begins. It follows the physical establishment of the channel and precedes normal information transfer. As used herein, the phrase “handshake signal,” includes a signal transmitted from a transmitter to a receiver that triggers the receiver to enter into a handshaking process. A return handshake signal is a signal from the receiver of a handshake signal, and in response to the received handshake signal, to the transmitter of the handshake signal to continue the handshaking process.

In one non-limiting example embodiment, a communication device, e.g., a smartphone: 1) automatically determines wither it is in a registered location; 2) automatically determines whether it is operating in a registered location mode; 2) automatically detects a handshake signal from a wireless transmitter of a wireless network; and 3) automatically connects to the network of the wireless transmitter transmitting the handshake signal.

In accordance with aspects of the present invention, a communication device may automatically determine whether it is operating in a location mode by any known method.

With respect to the communication device detecting a handshake signal, the detection may take the form of detecting a handshake signal, and comparing the detected handshake signal with previously stored handshake signal.

For purposes of discussion, consider the situation where a person is carrying a smart phone and is walking in an area that is not previously registered to have a transmitter that is able to transmit a short wavelength handshake signal in order to enable connection to a wireless network, e.g., a Bluetooth™ transmitter. A communication device in accordance with the present invention may not actively search for a handshake signal, thus saving power.

Now consider the situation where the same person is carrying the smart phone and is walking in another area that has been previously registered to have a transmitter able to transmit a short wavelength handshake signal in order to enable connection to a wireless network, e.g., a Bluetooth™ transmitter. A communication device in accordance with the present invention may automatically recognize the location, then automatically actively search for a handshake signal and then connect to the network.

As such, a communication device in accordance with aspects of the present invention will save batter power by not searching for a handshake signal when one is not likely to be present.

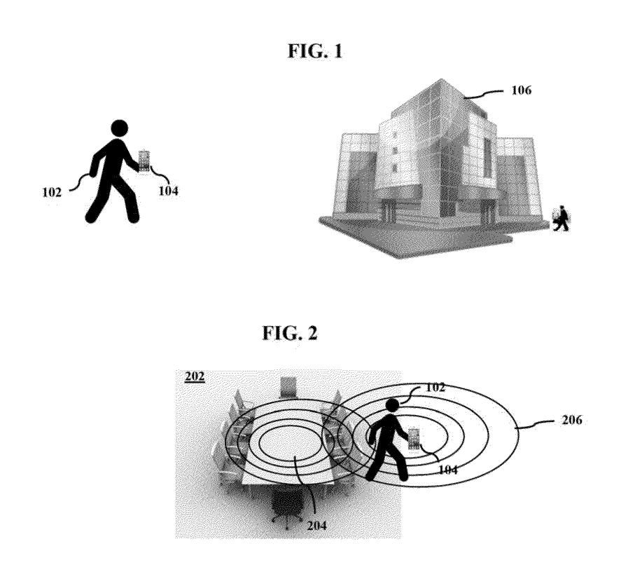

Aspects of the present invention will now be described with reference to FIGS. 1-12.

FIG. 1 illustrates a person 102 walking with a communication device 104 in accordance with aspects of the present invention.

As shown in the figure, person 102 is walking outside of a building 106. In this situation, communication device 104 is not actively searching for a short wavelength frequency band to connect to a network. As such, communication device 104 is saving power. Communication device 104 will nevertheless be able to determine when to actively search for a short wavelength frequency band to connect to a network. This will be described with reference to FIG. 2.

FIG. 2 illustrates person 102 with communication device 104 in an office 202 in accordance with aspects of the present invention.

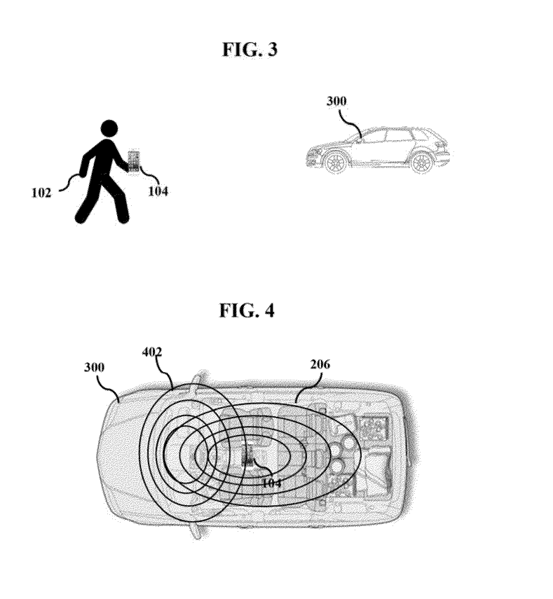

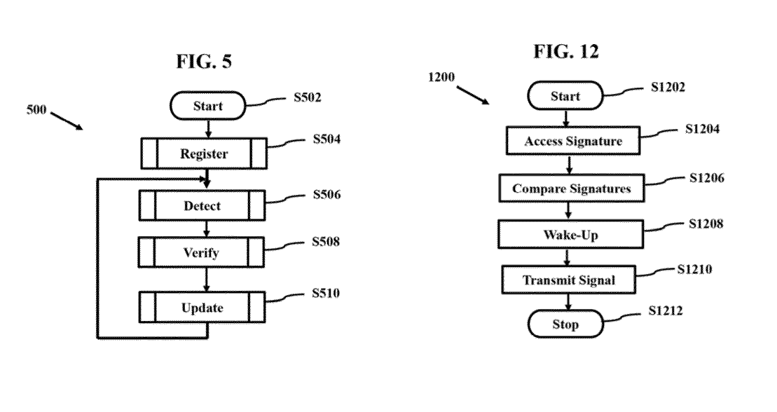

As shown in the figure, person 102 is in office 202, wherein office 202 includes a wireless transmitter (not shown) that is broadcasting a handshake signal 204. In this situation, communication device 104 recognizes office 202 and actively searches for a short wavelength frequency band to connect to a network. Once communication device 104 detects handshake signal 204, communication device 104 responds with a transmission signal 206 in order to connect to the wireless network of the transmitter in office 202. Additional examples of communication device 104 determining when to actively search for a short wavelength frequency band to connect to a network will be described with reference to FIGS. 3-4.

FIG. 3 illustrates person 102 with communication device 104 walking toward a vehicle 300.

In this situation, similar to the situation discussed above with reference to FIG. 1, communication device 104 is not actively searching for a short wavelength frequency band to connect to a network. As such, communication device 104 is saving power. Communication device 104 will nevertheless be able to determine when to actively search for a short wavelength frequency band to connect to a network. This will be described with reference to FIG. 4.

FIG. 4 illustrates when person 102 (not shown) is sitting in vehicle 300, and is using a device in accordance with aspects of the present invention.

As shown in the figure, vehicle 300 includes a wireless transmitter (not shown) that is broadcasting a handshake signal 402. In this situation, communication device 104 recognizes vehicle 300 and actively searches for a short wavelength frequency band to connect to a network. Once communication device 104 detects handshake signal 402, communication device 104 responds with transmission signal 206 in order to connect to the wireless network of the transmitter in vehicle 300.

Example methods of detecting a predetermined location and then actively detecting wireless handshake signals in accordance with aspects of the present invention will now be described with additional reference to FIGS. 5-12.

FIG. 5 illustrates an example method 500 of detecting a wireless handshake signal via a communication device in accordance with aspects of the present invention.

Method 500 starts (S502) and a location, a location mode and a handshake signal are registered (S504).

As for registration of a location, any known method may be used, a non-limiting example of which is disclosed in for example, U.S. utility patent application Ser. No. 14/092,231 filed Nov. 5, 2013.

As for registration of a location mode, any known method may be used, a non-limiting example of which is disclosed in for example, U.S. utility patent application Ser. No. 14/095,156 filed Dec. 3, 2013.

As for registration of a handshake signal, for example, a user may register any known handshake signal, a non-limiting example of which includes that of the Bluetooth™ standard.

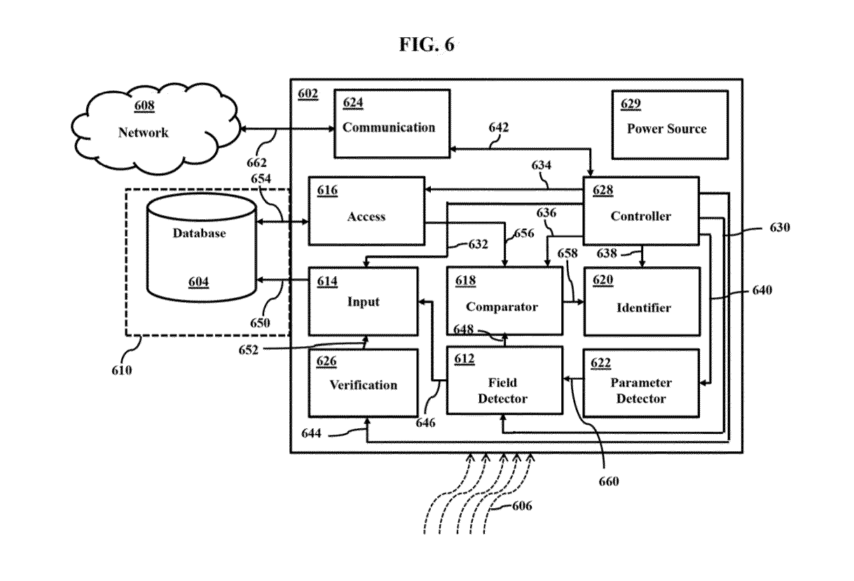

A more detailed discussion of registration of a location, a location mode and a handshake signal will now be provided with additional reference to FIGS. 6-12.

FIG. 6 illustrates an example device 602 in accordance with aspects of the present invention.

FIG. 6 includes a device 602, a database 604, a field 606 and a network 608. In this example embodiment, device 602 and database 604 are distinct elements. However, in some embodiments, device 602 and database 604 may be a unitary device as indicated by dotted line 610.

Device 602 includes a field-detecting component 612, an input component 614, an accessing component 616, a comparing component 618, an identifying component 620, a parameter-detecting component 622, a communication component 624, a verification component 626, a controlling component 628 and a power source 629.

In this example, field-detecting component 612, input component 614, accessing component 616, comparing component 618, identifying component 620, parameter-detecting component 622, communication component 624, verification component 626, controlling component 628 and power source 629 are illustrated as individual devices. However, in some embodiments, at least two of field-detecting component 612, input component 614, accessing component 616, comparing component 618, identifying component 620, parameter-detecting component 622, communication component 624, verification component 626, controlling component 628 and power source 629 may be combined as a unitary device. Further, in some embodiments, at least one of field-detecting component 612, input component 614, accessing component 616, comparing component 618, identifying component 620, parameter-detecting component 622, communication component 624, verification component 626, controlling component 628 and power source 629 may be implemented as a computer having tangible computer-readable media for carrying or having computer-executable instructions or data structures stored thereon. Such tangible computer-readable media can be any available media that can be accessed by a general purpose or special purpose computer. Non-limiting examples of tangible computer-readable media include physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. For information transferred or provided over a network or another communications connection (either hardwired, wireless, or a combination of hardwired or wireless) to a computer, the computer may properly view the connection as a computer-readable medium. Thus, any such connection may be properly termed a computer-readable medium. Combinations of the above should also be included within the scope of computer-readable media.

Controlling component 628 is arranged to communicate with: field-detecting component 612 via a communication line 630; input component 614 via a communication line 632; accessing component 616 via a communication line 634; comparing component 618 via a communication line 636; identifying component 620 via a communication line 638; parameter-detecting component 622 via a communication line 640; communication component 624 via a communication line 642; and verification component 626 via a communication line 644. Controlling component 628 is operable to control each of field-detecting component 612, input component 614, accessing component 616, comparing component 618, identifying component 620, parameter-detecting component 622, communication component 624 and verification component 626.

Field-detecting component 612 is additionally arranged to detect field 606, to communicate with input component 614 via a communication line 646, to communicate with comparing component 618 via a communication line 648 and to communicate with parameter-detecting component 622 via a communication line 645. Field-detecting component 612 may be any known device or system that is operable to detect a field, non-limiting examples of which include an electric field, a magnetic field, and electro-magnetic field and combinations thereof. In some non-limiting example embodiments, field-detecting component 612 may detect the amplitude of a field at an instant of time. In some non-limiting example embodiments, field-detecting component 612 may detect a field vector at an instant of time. In some non-limiting example embodiments, field-detecting component 612 may detect the amplitude of a field as a function over a period of time. In some non-limiting example embodiments, field-detecting component 612 may detect a field vector as a function over a period of time. In some non-limiting example embodiments, field-detecting component 612 may detect a change in the amplitude of a field as a function over a period of time. In some non-limiting example embodiments, field-detecting component 612 may detect a change in a field vector as a function over a period of time. Field-detecting component 612 may output a signal based on the detected field.

Input component 614 is additionally arranged to communicate with database 604 via a communication line 650 and to communicate with verification component 626 via a communication line 652. Input component 614 may be any known device or system that is operable to input data into database 604. Non-limiting examples of input component 614 include a graphic user interface (GUI) having a user interactive touch screen or keypad.

Accessing component 616 is additionally arranged to communicate with database 604 via a communication line 654 and to communicate with comparing component 618 via a communication line 656. Accessing component 616 may be any known device or system that access data from database 604.

Comparing component 618 is additionally arranged to communicate with identifying component 620 via a communication line 658. Comparing component 618 may be any known device or system that is operable to compare two inputs.

Parameter-detecting component 622 is additionally arranged to communicate with identifying component 622 via a communication line 290. Parameter-detecting component 622 may be any known device or system that is operable to detect a parameter, non-limiting examples of which include velocity, acceleration, angular velocity, angular acceleration, geodetic position, light, sound, temperature, vibrations, pressure, biometrics, contents of surrounding atmosphere, a change in geodetic position, a change in light, a change in sound, a change in temperature, a change in vibrations, a change in pressure, a change in biometrics, a change in contents of surrounding atmosphere and combinations thereof. In some non-limiting example embodiments, parameter-detecting component 622 may detect the amplitude of a parameter at an instant of time. In some non-limiting example embodiments, parameter-detecting component 622 may detect a parameter vector at an instant of time. In some non-limiting example embodiments, parameter-detecting component 622 may detect the amplitude of a parameter as a function over a period of time. In some non-limiting example embodiments, parameter-detecting component 622 may detect a parameter vector as a function over a period of time. In some non-limiting example embodiments, parameter-detecting component 622 may detect a change in the amplitude of a parameter as a function over a period of time. In some non-limiting example embodiments, parameter-detecting component 622 may detect a change in a parameter vector as a function over a period of time.

Communication component 624 is additionally arranged to communicate with network 608 via a communication line 662. Communication component 624 may be any known device or system that is operable to communicate with network 608. Non-limiting examples of communication component include a wired and a wireless transmitter/receiver.

Verification component 626 may be any known device or system that is operable to provide a request for verification. Non-limiting examples of verification component 626 include a graphic user interface having a user interactive touch screen or keypad.

Power source 629 may be any known device or system that is operable to provide power to field-detecting component 612, input component 614, accessing component 616, comparing component 618, identifying component 620, parameter-detecting component 622, communication component 624, verification component 626 and controlling component 628. Non-limiting examples of power source 629 include a battery and a capacitor. Power source 629 may deliver power to field-detecting component 612, input component 614, accessing component 616, comparing component 618, identifying component 620, parameter-detecting component 622, communication component 624, verification component 626 and controlling component 628 by any known manner, non-limiting examples of which include a bus and a wire network.

Communication lines 630, 632, 634, 636, 638, 640, 642, 644, 645, 646, 648, 650, 652, 654, 656, 658, 290 and 662 may be any known wired or wireless communication line.

Database 604 may be any known device or system that is operable to receive, store, organize and provide (upon a request) data, wherein the “database” refers to the data itself and supporting data structures. Non-limiting examples of database 604 include a memory hard-drive and a semiconductor memory.

Network 608 may be any known linkage of two or more communication devices. Non-limiting examples of database 608 include a wide-area network, a local-area network and the Internet.

For purposes of discussion, consider the following example where a person is driving vehicle 300 of FIG. 4 and is carrying device 102, which is in a location mode.

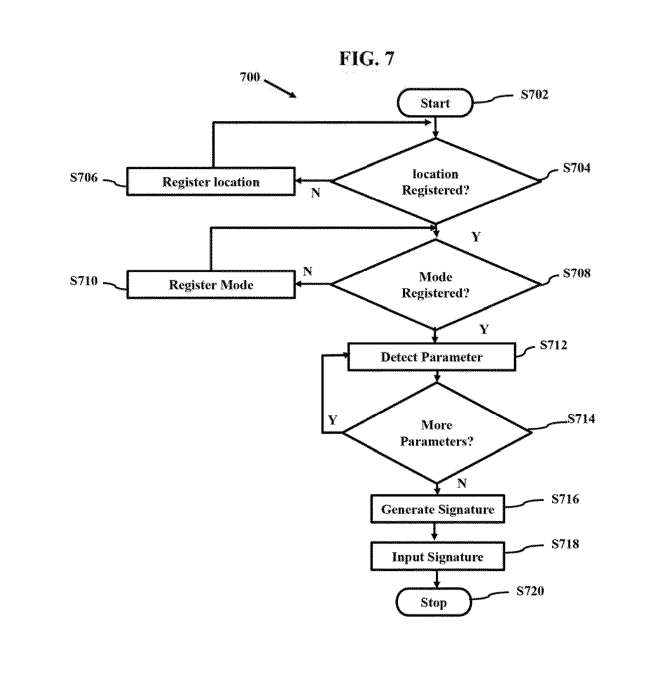

FIG. 7 illustrates an example method 700 of registering a handshake signal in accordance with aspects of the present invention.

As shown in the figure, method 700 starts (S702) and it is determined whether the current location is registered (S704). In this example, the location is a vehicle. For example, detected parameters of the current vehicle may be used to generate a vehicle signature associated with the current vehicle. This type of vehicle signature generation may be performed by any known method, a non-limiting example of which is disclosed in U.S. patent application Ser. No. 14/092,231. As shown in FIG. 6, the vehicle signature for the current vehicle may be stored in database 604. Databased 604 may have a plurality of vehicle signatures for a plurality of vehicles, each of which may have been supplied to database 604 as a priori information.

Returning to FIG. 7, if it is determined that the current location is not registered (N at S704), then the location is registered (S706). For example, returning to FIG. 6, controlling component 628 may register the current vehicle.

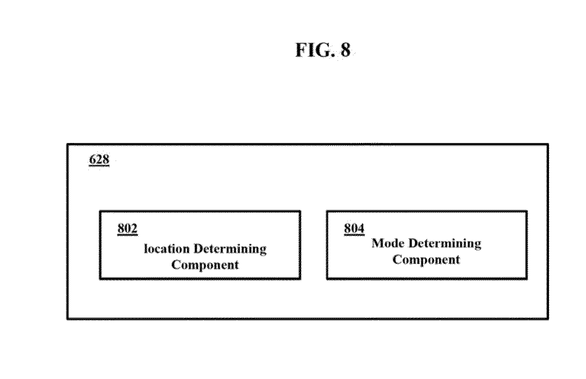

FIG. 8 illustrates an example controlling component 628.

As shown in the figure, controlling component 628 includes a location determining component 802 and a mode determining component 804.

In this example, location determining component 802 and mode determining component 804 are illustrated as individual devices. However, in sonic embodiments, location determining component 802 and mode determining component 804 may be combined as a unitary device. Further, in some embodiments, at least one of location determining component 802 and mode determining component 804 may be implemented as a computer having tangible computer-readable media for carrying or having computer-executable instructions or data structures stored thereon.

Location determining component 802 may be any device or system that is able to determine whether device 602 is in a predetermined vehicle. Mode determining component 804 may be any device or system that is able to determine whether device 602 is in a location mode.

One non-limiting example of location determining component 802 being able to register the current vehicle includes the situation when a user instructs device 602 to register the current vehicle by way of input component 614. For example, a user may activate an icon on the GUI to indicate that device 602 is now in a vehicle. Such activation of the GUI would inform location determining component 802 that device 602 is in a predetermined vehicle. Location determining component 802 may then generate a location signal indicating that device 602 is in the predetermined location, which in this example is a predetermined vehicle.

Another non-limiting example of location determining component 802 being able to register the current vehicle includes detecting a field by way of field-detecting component 612. For example, returning to FIG. 6, field-detecting component 612 detects field 606. For purposes of discussion, let field 606 be a magnetic field corresponding to the superposition of magnetic fields generated by all electronic and mechanical systems invoked with the running vehicle. A detected field signature may be compared with a priori field signature by any known manner, a non-limiting example of which includes that as described in U.S. patent application Ser. No. 14/092,231.

Another non-limiting example of location determining component 802 being able to register the current vehicle includes detecting other parameters by way of parameter-detecting component 622. These other detected parameters may be used to generate a vehicle signature, which in turn will be compared with a priori vehicle signatures by any known manner, a non-limiting example of which includes that as described in U.S. patent application Ser. No. 14/092,231.

In some embodiments, device 602 has a predetermined number of parameters to detect, wherein controlling component 628 may control such detections. For example, the first parameter to be detected may be a magnetic field associated with a running vehicle, wherein controlling component 628 may instruct field-detecting component 612 to detect a magnetic field. Further, a second parameter to be detected may be another known detected parameter additionally associated with the running vehicle, e.g., vibrations in the chassis, wherein controlling component 628 may instruct parameter-detecting component 622 to detect the second parameter. Further parameter-detecting component 622 may be able to detect many parameters.

For example, detected parameters of the current vehicle may be used to generate a vehicle signature associated with the current vehicle. This type of vehicle signature generation may be performed by any known method, a non-limiting example of which is disclosed in U.S. patent application Ser. No. 14/092,231, wherein location determining component 802 may control field-detecting component 612, parameter-detecting component 622, comparing component 618 and input component 614 to generate and store a vehicle signature of the current vehicle into database 604.

At this point, in this example, the vehicle of the user of device 602 is registered. As such, device 602 will now automatically recognize when it is in the vehicle of the user of device 602.

Returning to FIG. 7, now that the current vehicle is registered (S706 then returns to S704), it is determined whether the location mode is registered (S708). For example, returning to FIG. 6, controlling component 628 may determine whether the location mode is registered. In some embodiments, device 602 may have specific preset modes, such as a vehicle mode, a sleep mode, a low power mode, a specific location mode, etc., wherein each mode is associated with a respective location.

Returning to FIG. 7, if it is determined that the location mode is not registered (N at S708), then the mode is registered (S710). For example, returning to FIG. 6, controlling component 628 may register the location mode. As shown in FIG. 8, mode determining component 804 may then generate a location mode signal indicating that device 602 is operating in the predetermined location mode, which in this example is a predetermined vehicle mode.

In some embodiments, device 602 may enable a user to establish modes, such as a vehicle mode, a sleep mode, a low power mode, a specific location mode, etc. . . . . In an example embodiment, the user may use the GUI to establish a mode by assigning a location mode to the current location.

In this manner, in some embodiments, controller may instruct input component 614 to input the relationships between registered vehicles and registered modes into database 604. These relationships may be stored in any known method, a non-limiting example of which includes a lookup table. When the determined vehicle corresponds to a previously registered vehicle, and the determined vehicle coincides with the determined vehicle mode, which corresponds to a previously registered location mode, then device 602 may automatically detect a handshake signal.

Returning to FIG. 7, in this example embodiment, the location mode is registered (S710) after the vehicle is registered (S704). However, in some embodiments, the mode may be registered prior to the vehicle being registered. Further, in some embodiments, the mode may be registered concurrently with the vehicle being registered.

After the mode is registered (S710), in this example, a parameter is detected (S712) in order to register a signature for a handshake signal—the actual handshake signal itself.

Returning to FIG. 7, after the first parameter is detected (S712), it is determined whether another parameter is to be detected (S714). For example, returning to FIG. 6, controlling component 628 may instruct at least one of field-detecting component 612 and parameter-detecting component 622 to detect another parameter.

The actual handshake signal may be a relatively distinct parameter to detect. However, there may be situations wherein a follow-up or verification handshake signal is used. As such, in some situations, a second parameter associated with a handshake signal may be used. Along this notion, it is an example aspect of the invention to detect a plurality of parameters associated with a handshake signal to increase the probability of a correct identification of the handshake signal.

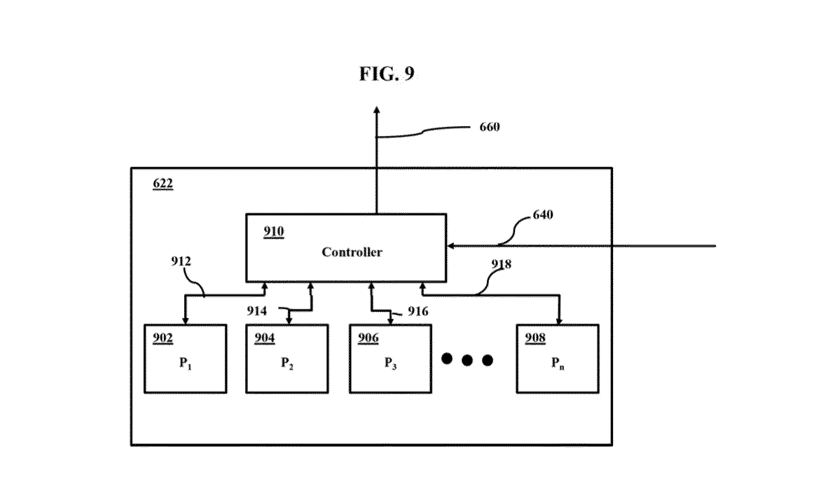

In some embodiments, device 602 has a predetermined number of parameters to detect, wherein controlling component 628 may control such detections. For example, the first parameter to be detected (in S712) may be the handshake signal, wherein controlling component 628 may instruct parameter-detecting component 622 to detect the handshake signal. Further, a second parameter to be detected may be another known detected parameter additionally associated with a handshake signal, e.g., a GPS signal, wherein controlling component 628 may instruct parameter-detecting component 622 to detect the second parameter as a GPS signal. In this manner, when device 602 is in a particular location that is associated with a handshake signal, such as for example the home of the user of device 602, then device 602 will know to search for the handshake signal. Further parameter-detecting component 622 may be able to detect many parameters. This will be described with greater detail with reference to FIG. 9.

FIG. 9 illustrates an example parameter-detecting component 622.

As shown in the figure, parameter-detecting component 622 includes a plurality of detecting components, a sample of which are indicated as a first detecting component 902, a second detecting component 904, a third detecting component 906 and an n-th detecting component 908. Parameter-detecting component 622 additionally includes a controlling component 910.

In this example, detecting component 902, detecting component 904, detecting component 906, detecting component 908 and controlling component 910 are illustrated as individual devices. However, in some embodiments, at least two of detecting component 902, detecting component 904, detecting component 906, detecting component 908 and controlling component 910 may be combined as a unitary device. Further, in some embodiments, at least one of detecting component 902, detecting component 904, detecting component 906, detecting component 908 and controlling component 910 may be implemented as a computer having tangible computer-readable media for carrying or having computer-executable instructions or data structures stored thereon.

Controlling component 910 is configured to communicate with: detecting component 902 via a communication line 912; detecting component 904 via a communication line 914; detecting component 906 via a communication line 916; and detecting component 908 via a communication line 918. Controlling component 910 is operable to control each of detecting component 902, detecting component 904, detecting component 906 and detecting component 908. Controlling component 910 is additionally configured to communicate with controlling component 628 of FIG. 6 via communication line 640 and to communicate with field-detecting component 612 of FIG. 6 via communication line 290.

The detecting components may each be a known detecting component that is able to detect a known parameter. For example each detecting component may be a known type of detector that is able to detect at least one of magnetic fields, electric fields, electro-magnetic fields, velocity, acceleration, angular velocity, angular acceleration, geodetic position, sound, temperature, an image, a Blue Tooth signal, a Wi-Fi signal, light, vibrations, pressure, biometrics, contents of surrounding atmosphere, a change in electric fields, a change in magnetic fields, a change in electro-magnetic fields, a change in velocity, a change in acceleration, a change in angular velocity, a change in angular acceleration, a change in geodetic position, a change in sound, a change in temperature, a change in light, a change in vibrations, a change in pressure, a change in biometrics, a change in contents of surrounding atmosphere and combinations thereof. For purposes of discussion, let: detecting component 902 be able to detect a handshake signal; detecting component 904 be able to detect a verification signal, detecting component 906 be able to detect vibrations; and detecting component 908 be able to detect geodetic position.

In some non-limiting example embodiments, at least one of the detecting components of parameter-detecting component 622 may detect a respective parameter as an amplitude at an instant of time. In some non-limiting example embodiments, at least one of the detecting components of parameter-detecting component 622 may detect a respective parameter as a function over a period of time.

Each of the detecting components of parameter-detecting component 622 is able to generate a respective detected signal based on the detected parameter. Each of these detected signals may be provided to controlling component 910 via a respective communication line.

Controlling component 910 is able to be controlled by controlling component 628 via communication line 640.

Returning to FIG. 7, if another parameter is to be detected (Y at S714), then another parameter will be detected (S712). For example, as shown in FIG. 6, controlling component 628 may then instruct parameter-detecting component 622 to detect another parameter via communication line 640. For purposes of discussion, let the second parameter to be detected be a GPS signal. As such, at this point, as shown in FIG. 9, controlling component 910 instructs detecting component 902, via communication line 912, to detect the GPS signal. Detecting component 902 provides a signal corresponding to the detected GPS signal to controlling component 910 via communication line 912.

This process will repeat until all the parameters to be detected are detected. In some embodiments, this process will repeat a predetermined number of times in order to detect predetermined types of parameters. In some embodiments, this process is only repeated until enough parameters are detected in order reach a predetermined probability threshold, which will reduce the probability of a false positive identification of a handshake signal.

Retuning to FIG. 9, as just discussed, controlling component 910 is able to send individual detected signals from each detecting component. In other example embodiments, controlling component 910 is able to receive and hold the individual detected signals from each detecting component, wherein controlling component 910 is able to generate a composite detected signal that is based on the individual detected signals. The composite detected signal may be based on any of the individual detected signal, and combinations thereof. In some embodiments, controlling component 910 may additionally process any of the individual detected signals and combinations thereof to generate the composite detected signal. Non-limiting examples of further processes include averaging, adding, subtracting, and transforming any of the individual detected signals and combinations thereof.

It should be further noted that in some embodiments, all parameters that are to be detected are detected simultaneously. In such a case, for example, as shown in FIG. 6, controlling component 628 may then instruct parameter-detecting component 622 to detect all parameters via communication line 640. As such, at this point, as shown in FIG. 9, controlling component 910 instructs all the detecting components to detect their respective parameters. All the detecting components then provide a respective signal corresponding to the respective detected parameter to controlling component 910 via communication line 914. In this example, controlling component 910 may then provide the detected signal to field-detecting component 612 via communication line 290 as shown in FIG. 6.

Returning to FIG. 7, if no more parameters are to be detected (N at S714), then a handshake signal signature is generated (S716). For example as shown in FIG. 6, parameter-detecting component 622 may generate a handshake signal signature of the handshake signal based on the detected parameter.

Returning to FIG. 7, once the handshake signal signature is generated (S716), the handshake signal signature in input into memory (S718). For example, as shown in FIG. 6, field-detecting component 612 provides the signature to input component 614 via communication line 646.

In an example embodiment, input component 614 includes a GUI that informs a user of device 602 that a handshake signal signature has been generated. Input component 614 may additionally enable the user to input an association between the registered location, the registered mode and the generated handshake signal signature. For example, input component 614 may display on a GUI a message such as “A signature was generated. To what handshake signal is the signature associated?” Input component 614 may then display an input prompt for the user to input, via the GUI, a handshake signal to be associated with the generated handshake signal signature.

Input component 614 may then provide the handshake signal signature, and the association to a specific location and mode, to database 604 via communication line 650.

As discussed above, in some embodiments, database 604 is part of device 602, whereas in other embodiments, database 604 is separate from device 602. Data input and retrieval from database 604 may be faster when database 604 part of device 602, as opposed to cases where database 604 is distinct from device 602. However, size may be a concern when designing device 602, particularly when device 602 is intended to be a handheld device such as a smartphone. As such, device 602 may be much smaller when database 604 is distinct from device 602, as opposed to cases where database 604 is part of device 602.

Consider an example embodiment, where database 604 is part of device 602. In such cases, input component 614 may enable a user to input handshake signal signatures and the location/mode associations, for a predetermined number of handshake signals. In this manner, database 604 will only be used for device 602.

Now consider an example embodiment, where database 604 is separate from device 602. Further, let database 604 be much larger than the case where database 604 is part of device 602. Still further, let database 604 be accessible to other devices in accordance with aspects of the present invention. In such cases, input component 614 may enable a user to input handshake signal signatures and the location/mode associations, for a much larger predetermined number of handshake signals. Further, in such cases, input component 614 may enable other users of similar devices to input handshake signal signatures and the location/mode associations, for even more handshake signals.

It should be noted that although the above-discussed example includes identifying a handshake signal, this is a non-limiting example. Aspects of the invention may additionally be used to identify any type of signal.

At this point, method 700 stops (S720).

A location, a mode of operation at the registered location, and a handshake signal have been registered. In accordance with aspects of the present invention, device 602 will be able to subsequently automatically determine when it is in the registered mode at the registered location. When device 602 automatically determines such situations, device 602 will search for handshake signal.

With a prior art system or method, a user may have to actuate a device to search for a short wavelength frequency band handshake signal when the user determines that he is in particular location and the phone is operating in a location mode. On the contrary, in accordance with aspects of the present invention, device 602 will automatically search for a handshake signal without any user involvement.

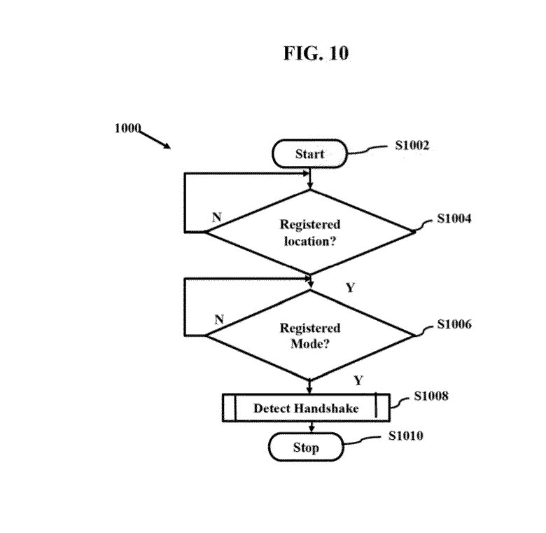

Returning to FIG. 5, now that a location, a location mode and a handshake signal have been registered (S504), a future handshake signal may be detected (S506). In other words, now that a location has been registered, and now that a mode of operation of device 602, within the location, has been registered, device 602 will detect whether it is in the registered location while operating in the location mode and a predetermined handshake signal is detected. This will further described with additional reference to FIG. 10.

FIG. 10 illustrates a method 1000 for detecting a handshake signal when in a registered location while operating in a registered mode.

As shown in the figure, method 100 starts (S1002) and it is determined whether the current location is a registered location (S1004). The current location may be detected by any known system or method. In an example embodiment, the location is detected in a manner as disclosed in U.S. patent application Ser. No. 14/105,934.

For example, returning to FIG. 8, a plurality of parameters may be detected via field-detecting component 612 and parameter-detecting component 622. The detected parameters may be used to generate a location signature of the current location. The generated location signature is then compared with previously stored location signatures associated with previously registered locations, as stored in database 604. When the generated location signature coincides with a previously stored location signature associated with previously registered location, identifying portion 620 identifies the current location as one of the previously registered locations.

If device 602 is not in a registered location (N at S1004), then method 1000 continues until it is determined that device 602 is in a registered location (Y at S1004).

Returning to FIG. 10, after determining that the current location is a registered location (Y at S1004), it is determined whether the current mode of operation is a registered location mode corresponding to the registered location (S1006). The current mode may be detected in a manner similar to that discussed above with reference to FIG. 7 (S708). In particular, for example, returning to FIG. 8, controlling component 628 may determine whether the current mode is registered.

If device 602 is not in a registered mode corresponding to the registered location (N at S1006), then method 1000 continues until it is determined that device 602 is in the corresponding registered mode (Y at S1004).

After determining that the current mode is the corresponding registered mode (Y at S1006), a handshake signal is detected (S1008). Consider, for example, the situation where a person is sitting in a vehicle that is broadcasting a handshake signal discussed above with reference to FIG. 4. In accordance with aspects of the present invention, device 602 may detect parameters associated with previously registered handshake signal. These detected parameters may be used to generate new handshake signal signatures.

By analyzing at least one detected parameter associated with device 602, it may be determined whether or not a handshake signal is present.

When device 602 is in a registered location and is operating in a registered mode corresponding to the registered location and a specific handshake signal is detected, a return handshake signal may be generated in order to complete the handshaking process.

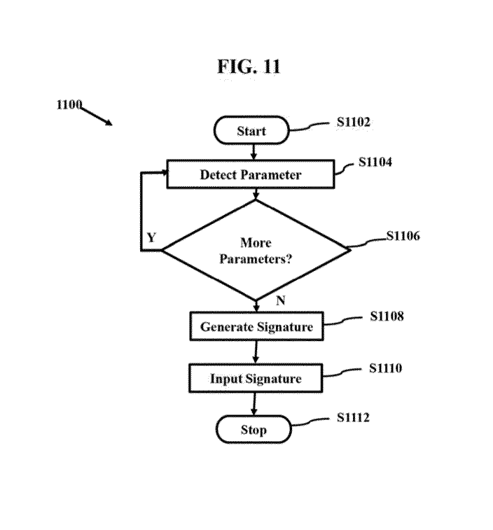

This aspect of the present invention will be further described with reference to FIG. 11.

FIG. 11 illustrates an example method 1100 of generating a handshake signal signature in accordance with aspects of the present invention.

As shown in the figure, method 1100 starts (S1102) and a parameter is detected (S1104). A parameter may be detected by any known method or system. In an example embodiment, a parameter is detected in a manner similar to that discussed above with reference to method 700, e.g., S712. Non-limiting examples of detected parameters include at least one of magnetic fields, electric fields, electro-magnetic fields, velocity, acceleration, angular velocity, angular acceleration, geodetic position, sound, temperature, an image, a Blue Tooth signal, a Wi-Fi signal, light, vibrations, pressure, biometrics, contents of surrounding atmosphere, a change in electric, fields, a change in magnetic fields, a change in electro-magnetic fields, a change in velocity, a change in acceleration, a change in angular velocity, a change in angular acceleration, a change in geodetic position, a change in sound, a change in temperature, a change in light, a change in vibrations, a change in pressure, a change in biometrics, a change in contents of surrounding atmosphere and combinations thereof.

Returning to FIG. 11, after the parameter has been detected (S1104), it is determined whether more parameters are to be detected (S1106). The additional parameters may be detected by any known method or system. In an example embodiment, additional parameters may be detected in a manner similar to that discussed above with reference to method 700, e.g., S714.

Returning to FIG. 11, if another parameter is to be detected (Y at S1106), then another parameter will be detected (S1104). This process will repeat until all the parameters to be detected are detected. In some embodiments, this process will repeat a predetermined number of times in order to detect predetermined types of parameters. In some embodiments, this process is only repeated until enough parameters are detected in order reach a predetermined probability threshold, which will reduce the probability of a false positive handshake signal determination.

A handshake signal signature is then generated (S1108). The handshake signal signature may be generated by any known method or system. In an example embodiment, a signature is generated a manner similar to that discussed above with reference to method 1000, e.g., S1008.

Returning to FIG. 11, after the handshake signal signature is generated (S1108), it is then inputted (S1110). As shown in FIG. 6, this second signature is provided to comparing component 618.

Method 1100 then stops (S1112). Returning to FIG. 10, method 1000 additionally stops (S1010).

In accordance with aspects of the present invention, method 1000 may be performed continuously, or at predetermined intervals. In some embodiments, a predetermined time threshold, tₜₕ is stored, for example in controlling component 618. The time threshold, tₜₕ, may be used to decrease the likelihood of a false positive identification of a handshake signal. This may be accomplished by performing method 1000 at a first time, t₁, then subsequently performing method 1000 a second time, t₂, wherein the difference between t₁ and t₂ is Δt. If performance of method 1000 indicates a handshake signal and if Δt>tₜₕ, then it is determined that there is indeed a handshake signal. In short, if the handshake signal is detected after a long enough period, it is likely to be an accurate detection of a handshake signal.

Returning to FIG. 5, after the handshake signal has been detected (S506), it is verified (S508). For example, a device in accordance with aspects of the present invention would determine whether the newly detected handshake signal is the handshake signal that was previously registered. A more detailed discussion of registration will now be provided with additional reference to FIG. 12.

FIG. 12 illustrates an example method 1200 of verifying a handshake signal in accordance with aspects of the present invention.

Method 1200 starts (S1202) and the previously stored handshake signal signature is accessed (S1204). For example, as shown in FIG. 6, access component 616 retrieves the previously-stored handshake signal signature from database 604 via communication line 654. Access component 616 then provides the retrieved, previously-stored handshake signal signature to comparator 618 via communication line 656.

Returning to FIG. 12, now that the previously stored handshake signal signature has been accessed (S1204), the handshake signal signatures are compared (S1206). For example, as shown in FIG. 6, comparator 618 compares the retrieved, previously stored handshake signal signature as provided by access component 616 with the newly generated handshake signal signature as provided by field-detecting component 612.

Returning to FIG. 12, now that the handshake signal signatures have been compared (S1206), the receiver wakes-up (S1208). For example, as shown in FIG. 6, comparator 618 provides an output to identifying component 620 via communication line 658. If the retrieved, previously stored handshake signal signature as provided by access component 616 matches the newly generated handshake signal signature as provided by field-detecting component 612, then the newly detected handshake signal is the same handshake signal that was previously registered. In such a case, identifying component 620 may indicate that the newly detected handshake signal is the same handshake signal that was previously registered. If the retrieved, previously stored handshake signal signature as provided by access component 616 does not match the newly generated handshake signal signature as provided by field-detecting component 612, then the newly detected handshake signal is not the same handshake signal that was previously registered. In such a case, identifying component 620 may indicate that the newly detected handshake signal is not the same handshake signal that was previously registered.

As for “waking up,” identifying component 620 provides the wake up signal to controlling component 628 via communication line 638. Controlling component 628 then instructs communication component 624, via the wake-up signal on communication line 642, to actively search for the handshake signal. For example, as shown in FIG. 4, device 104 would detect the broadcasted handshake signal 402. This may performed, as shown in FIG. 6, by communication component 624 detecting the broadcasted handshake signal 402. By actively searching for the broadcasted handshake signal 402, communication component 624 will use more power from power source 629. However, in accordance with aspects of the present invention, this extra power will only be expended after device 602 has determined that there is a broadcasted handshake signal 402 to be detected. This should be contrasted with the situation, for example as shown in FIG. 2, wherein device 602 would not have determined that there is a broadcasted handshake signal to be detected.

Accordingly, device 602 save power of power source 629 by not continuously searching for a handshake signal.

Returning to FIG. 12, now that communication component has woken up (S1208), a return handshake signal is transmitted (S1210). For example, returning to FIG. 6, controlling component 628 instructs communication component 624 to transmit a return handshake signal to complete the handshaking process with the transmitter (not shown). In this example embodiment, communication component 624 transmits the return handshake signal in the same short wavelength frequency band of the received handshake signal from the transmitter (not shown).

At this point, method 1200 stops (S1212).

Returning to FIG. 5, after the handshake signal has been verified, the data is updated (S510). For example, in some embodiments, as shown in FIG. 6, comparator 618 may determine that the previously stored handshake signal signature as provided by access component 616 does not exactly match the newly generated handshake signal signature as provided by field-detecting component 612, but the difference between the previously stored handshake signal signature as provided by access component 616 does not exactly match the newly generated handshake signal signature as provided by field-detecting component 612 is within a predetermined acceptable limit. In such cases, identifying component 620 may indicate that the newly detected handshake signal is still the same handshake signal that was previously registered. Further, comparator 618 may provide the newly generated handshake signal signature as provided by field-detecting component 612 to access component 616 via communication line 656. Access component 616 may then provide the newly generated handshake signal signature to database 604 via communication line 654.

In this manner, database 604 may be “taught” to accept variations of previously registered handshake signal signatures. In some embodiments, an average of recognized handshake signal signatures may be stored for future use. In some embodiments, as plurality of each recognized handshake signal signature may be stored for future use.

Returning to FIG. 5, after updating (S510) device 602 waits to detect a new handshake signal (S506) and method 500 continues.

The example embodiments discussed above are drawn to identifying, via a communication device, a location using fields and other parameters associated therewith. Once in an identified location, and in a location mode, the communication device may automatically detect a handshake signal.

Another aspect of the present invention is drawn to a manual override. In particular, there may be situations where a user may want device 602 to search for a handshake signal, even though the user is not in a location that is known to have as transmitter that is transmitting such a handshake signal.

For example, consider the situation where the user of device 602 is walking through a public place, say a mall, and the user does not know whether the mall has a Bluetooth™ or Wi-Fi enabled communication system. In such a situation, the user of device 602 may override the method discussed above with reference to FIGS. 5-12.

For example, a GUI of input component input component 614 may generate a user interface signal in response to a user action, such as a user input. Input component 614 may then provide the user interface signal to controlling component 628 via communication line 632. Controlling component 628 may then generate an override signal based on the user interface signal. In this manner, controlling component 628 acts as an override component.

The override signal enables communication component 624 to actively search for a handshake signal without performing the methods discussed above with reference to FIGS. 5-12. Therefore, communication component 624 will be able to detect a handshake signal and generate a return handshake signal within the short wavelength frequency band.

In should be noted that in some embodiments, device 602 may include a distinct override element that is able to generate the override signal based on the user interface signal.

In the examples discussed above, detected handshake signals are compared with previously stored handshake signals (e.g., S1206 of F1G. 12) to reduce the likelihood of starting an active search for a handshake signal to start a handshaking process. It should be noted that in sonic embodiment, a comparison is not needed. In particular, in some embodiment, as soon as a device in accordance with aspects of the present determines that it is in a registered location and is operating in a registered mode, it will actively search for a handshake signal. If a handshake signal is present, a device in accordance with aspects of the present invention will perform the handshake procedure.

As mentioned previously, a problem with conventional wireless communication devices that are Bluetooth™ enabled, the communication devices constantly search for a Bluetooth™ handshake from a Bluetooth™ transmitter. Such constant searching quickly depletes the battery or other power source. In some communication devices, a user may be able to manually deactivate a Bluetooth™ searching function. However, this manual deactivation is sometimes overlooked, wherein the device quickly loses power.

In accordance with aspects of the present invention, a wireless communication devices that is Bluetooth™ enabled will not constantly search for a Bluetooth™ handshake from a Bluetooth™ transmitter. On the contrary, in accordance with aspects of the present invention, a wireless communication device will search for a handshake signal either with a manual override, such as indicated by the user via a GUI, or automatically after automatically determining that the device is in a previously registered location and operating in a previously registered mode. In this manner, the power of the device is saved since it only searches for a handshake signal when one is likely to be in range.

In the drawings and specification, there have been disclosed embodiments of the invention and, although specific terms are employed, they are used in a generic and descriptive sense only and not for purposes of limitation, the scope of the invention being set forth in the following claims.

What is claimed as new and desired to be protected by Letters Patent of the United States is:

1. A device for use with a wireless transceiver operable to transmit a handshake signal within a short wavelength frequency hand, said device comprising:
a processing component operable to operate in a first mode and to operate in a second mode;
a location determining component operable to determine when said processing component is in a predetermined location and to generate a location signal when said processing component is in the predetermined location;
a mode determining component operable to generate a location mode signal based on the location signal;
a detecting component operable to detect, based on the location signal, the handshake signal and to generate a wake-up signal based on the handshake signal; and
a transmitting component operable to transmit, based on the wake-up signal, a transmission signal to the wireless transceiver within the short wavelength frequency band.

2. The device of claim 1, further comprising:
a user interface component operable to generate a user interface signal based on a user action; and
an override component operable to generate an override signal based on the user interface signal,
wherein said transmitting component is further operable to transmit, based on the override signal, a second transmission signal within the short wavelength frequency band.

3. The device of claim 2, wherein said detecting component is operable to detect the handshake signal within one of the group consisting of a 2.4 GHz to 2.5 GHz frequency band, a 3.64 GHz to 3.9 GHz frequency band, a 5.18 GHz to 5.83 GHz frequency band, a 490 MHz to 910 MHz frequency band and a 59.0-64.0 GHz frequency band.

4. The device of claim 3, wherein said transmitting component is operable to transmit the transmission signal as a transmission signal within one of the group consisting of a 2.4 GHz to 2.5 GHz frequency band, a 3.64 GHz to 3.9 GHz frequency band, a 5.18 GHz to 5.83 GHz frequency band, a 490 MHz to 910 MHz frequency band and a 59.0-64.0 GHz frequency band.

5. A method for use with a wireless transceiver operable to transmit a handshake signal within a short wavelength frequency band, said method comprising:
operating a processing component, which is operable to operable operate in a first mode and to operate in a second mode;
determining, via a location determining component, when the processing component is in a predetermined location;
generating, via the location determining component, a location signal based on the detection of the predetermined location;
generating, via a mode determining component, a location mode signal when the processing component is operating in the location mode;
detecting, via a detecting component and based on the location signal and the location mode signal, the handshake signal;
generating, via the detecting component, a wake-up signal based on the detected handshake signal; and
transmitting, via a transmitting component and based on the wake-up signal, a transmission signal to the wireless transceiver within the short wavelength frequency band.

6. The method of claim 5, further comprising:
generating, via a user interface component, a user interface signal based on a user action:
generating, via an override component, an override signal based on the user interface signal; and
transmitting, via the transmitting component and based on the override signal, a second transmission signal within the short wavelength frequency band.

9. The method of claim 6, wherein said detecting the handshake signal comprises detecting the handshake signal within one of the group consisting of a 2.4 GHz to 2.5 GHz frequency band, a 3.64 GHz to 3.9 GHz frequency band, a 5.18 GHz to 5.83 GHz frequency band, a 490 MHz to 910 MHz frequency band and a 59.0-64.0 GHz frequency band.

8. The method of claim 9, wherein said transmitting the transmission signal comprises transmitting the transmission signal as a transmission signal within one of the group consisting of a 2.4 GHz to 2.5 GHz frequency band, a 3.64 GHz to 3.9 GHz frequency band, a 5.18 GHz to 5.83 GHz frequency band, a 490 MHz to 910 MHz frequency band and a 59.0-64.0 GHz frequency band.

9. A non-transitory, tangible, computer-readable media having computer-readable instructions stored thereon, for use with a wireless transceiver operable to transmit a handshake signal within a short wavelength frequency band, the computer-readable instructions being capable of being read by a computer and being capable of instructing the computer to perform the method comprising:
operating a processing component, which is operable to operable to operate in a location mode and a second mode, in a location mode when in the location;
determining, via a location determining component, when the processing component is in the location;
generating, via the location determining component, a location signal based on the detection;
generating, via a mode determining component, a location mode signal when the processing component is operating in the location mode;
detecting, via a detecting component and based on the location signal and the location mode signal, the handshake signal;
generating, via the detecting component, a wake-up signal based on the detected handshake signal; and
transmitting, via a transmitting component and based on the wake-up signal, a transmission signal to the wireless transceiver within the short wavelength frequency band.

10. The non-transitory, tangible, computer-readable media of claim 9, wherein the computer-readable instructions are capable of instructing the computer to perform the method further comprising:
generating, via a user interface component, a user interface signal based on to user action;
generating, via an override component, an override signal based on the user interface signal; and
transmitting, via the transmitting component and based on the override signal, a second transmission signal within the short wavelength frequency band.

11. The non-transitory, tangible computer-readable media of claim 10, wherein the computer-readable instructions are capable of instructing the computer to perform the method such that said detecting the handshake signal comprises detecting the handshake signal within one of the group consisting of a 2.4 GHz to 2.5 GHz frequency band, a 3.64 GHz to 3.9 GHz frequency band, a 5.18 GHz to 5.83 GHz frequency band, a 490 MHz to 910 MHz frequency band and a 59.0-64.0 GHz frequency band.

12. The non-transitory, tangible, computer-readable media of claim 11, wherein the computer-readable instructions are capable of instructing the computer to perform the method such that said transmitting the transmission signal comprises transmitting the transmission signal as a transmission signal within one of the group consisting of a 2.4 GHz to 2.5 GHz frequency band, a 3.64 GHz to 3.9 GHz frequency band, a 5.18 GHz to 5.83 GHz frequency band, a 490 MHz to 910 MHz frequency band and a 59.0-64.0 GHz frequency band.
